(19) United States
(12) Patent Application Publication
(10) Pub. No.: US 2023/0301472 A1
(43) Pub. Date: Sep. 28, 2023

(54) HEATING SEAT RING

(71) Applicant: TAIZHOU LARSEN HIGH TECH CO., LTD., Taizhou (CN)

(72) Inventor: TAO YANG, Taizhou (CN)

(21) Appl. No.: 17/748,056

(22) Filed: May 19, 2022

(30) Foreign Application Priority Data
Mar. 28, 2022 (CN) 202220700655.X

(51) Int. Cl. A47K 13/30

(52) U.S. Cl. CPC A47K 13/305

(57) ABSTRACT

A heating seat ring includes a lower seat ring and an upper seat ring. The lower seat ring is made of a hard material, the upper seat ring is made of a soft material, and the upper seat ring is disposed on the lower seat ring. The upper seat ring and the lower seat ring are matched and connected to form a heating cavity. A heating assembly is disposed in the heating cavity, and the heating assembly is configured to emit heat to heat the upper seat ring. The heating assembly emits heat to heat the upper seat ring, so that a user feels more comfortable when sitting on the heating seat ring.

### TECHNICAL FIELD

The present disclosure relates to a technical field of seat rings, and in particular to a heating seat ring.

### BACKGROUND

Seat rings are one component for toilets. With an improvement of living standards of people, the seat ring can be heated in cold weather to improve comfort of use.

Chinese patent application No. 201420227840.7 disclosed a heating toilet seat ring including a heating wire and an adhesive layer. The heating wire and the adhesive layer are disposed on a bottom plane of the heating toilet seat ring. The heating wire is disposed between the bottom plane of the toilet seat ring and the adhesive layer. Toilet seat ring is disposed on a ceramic body during use, and the ceramic body is further a good heat conductor. Therefore, heat generated through the heating wire of the heating toilet seat ring is easily dissipated outwards through the ceramic body or an air and the heating wire needs to be continuously heated, temperature rises slowly, which results in a poor energy-saving effect.

### SUMMARY

A purpose of the present disclosure is to provide a heating seat ring.

The purpose of the present disclosure is realized as follows:

A heating seat ring includes a lower seat ring and an upper seat ring. The lower seat ring is made of a hard material, the upper seat ring is made of a soft material, and the upper seat ring is disposed on the lower seat ring. The upper seat ring and the lower seat ring are matched and connected to form a heating cavity. A heating assembly is disposed in the heating cavity, and the heating assembly is configured to emit heat to heat the upper seat ring.

Optionally, the heating assembly includes two heating plates, and the heating plates are respectively disposed on a left side of the lower surface of the upper seat ring and a right side of the lower surface of the upper seat ring.

Optionally, a heat insulation plate is disposed in the heating cavity, and the heat insulation plate is disposed on a lower side of the heating assembly.

Optionally, the heating assembly and the heat insulation plate are attached to each other, and the heating assembly is attached to a lower surface of the upper seat ring.

Optionally, the heating cavity covers the heating assembly and the heat insulation plate, and an inner wall of the heating cavity is attached to a peripheral side of the heating assembly and the heat insulation plate.

Optionally, the lower seat ring includes a bottom bracket and a framework plate. The framework plate is disposed on the bottom bracket. The upper seat ring is coated on the framework plate. The upper seat ring and the framework plate are matched and connected to form the heating cavity.

The framework plate and the bottom bracket are matched and connected to form a mounting cavity, and the mounting cavity is configured to mount a circuit and components.

Optionally, a wiring channel is disposed on a lower surface of the framework plate. A charging interface is disposed on one side of the mounting cavity. The charging interface is connected to the heating assembly through a line. An inner end of the charging interface is disposed on one side of an opening of the wiring channel.

Optionally, the framework plate includes an inner ring portion and an outer ring portion. A plurality of through holes are respectively defined on the inner ring portion and the outer ring portion. The plurality of the through holes penetrate through an upper surface of the framework plate and the lower surface of the framework plate.

The upper seat ring includes a foaming layer. The foaming layer fills the through holes and covers the inner ring portion of the framework plate and the outer ring portion of the framework plate.

Optionally, the upper seat ring further includes a waterproof film. The waterproof film is attached to an outer surface of the foaming layer. An outer end of the waterproof film and an inner end of the waterproof film are tightly clamped through the bottom bracket.

Optionally, the bottom bracket and the framework plate are connected through thermal welding, and an overflow groove is defined at a joint of the bottom bracket and the framework plate.

Compared with prior art, beneficial technical effects of the present disclosure are as follows:

1. The present disclosure emits heat to heat the upper seat ring through the heating assembly, so that users are more comfortable when sitting on the heating seat ring. Meanwhile, compared with an upper seat ring made of a conventional hard material, the upper seat ring made of the soft material further better transmits the heat emitted through the heating assembly, which reduces a loss of heat in a transfer process. Therefore, the heating assembly heats the upper seat ring to a set temperature in a shorter time, thereby achieving the effect of energy saving. At the same time, the heating cavity further plays a role in protecting the heating assembly, reducing a possibility that the heating assembly is damaged due to external force.

2. The two heating plates are respectively disposed on the left side of the lower surface of the upper sea ring and the right side of the lower surface of the upper seat ring. By adopting a design of the heating plates on the left side and the right side, an installation space of the heating assembly is reduced as much as possible, and meanwhile, the heating assembly accurately heats an area on the upper seat ring where buttocks of the users abut, which ensures comfort of use, reduces a volume of the heating assembly, and reduces a production cost.

3. The present disclosure reduces downward transfer of the heat of the heating assembly through the heat insulation plate, effectively keeps the heat above the heat insulation plate, and keeps the temperature of the upper seat ring stable. Then the heating assembly does not need to be repeatedly improved temperature and heated to keep stability of the upper seat ring. Finally, the energy-saving effect is further improved while heat preservation is achieved.

### BRIEF DESCRIPTION OF DRAWINGS

FIG. 1 is an overall structural schematic diagram of a heating seat ring according to one embodiment of the present disclosure.

FIG. 2 is an exploded schematic diagram of the heating seat ring according to one embodiment of the present disclosure.

FIG. 3 is a partial cross-sectional schematic diagram of the heating seat ring according to one embodiment of the present disclosure.

FIG. 4 is a structural schematic diagram of a back surface of a framework plate according to one embodiment of the present disclosure.

FIG. 5 is a structural schematic diagram of a front surface of the framework plate according to one embodiment of the present disclosure.

Reference number in the drawings: 1. lower seat ring; 2. upper seat ring; 3. heating cavity; 4. heating assembly; 5. heat insulation plate; 6. bottom bracket; 7. framework plate; 8. mounting cavity; 9. wiring channel; 10. threading holes; 11. charging interface; 12. overflow groove; 13. switch; 14. indicator lights; 15. flip cover; 16. inner ring portion; 17. outer ring portion; 18. through holes; 19. foaming layer; 20. waterproof film.

### DETAILED DESCRIPTION

Specific embodiments of the present disclosure are further described in details below with reference to accompanying drawings.

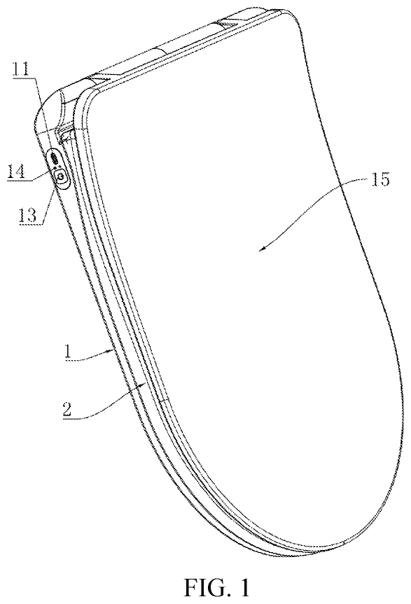

As shown in FIGS. 1-4, a heating seat ring includes a lower seat ring 1 and an upper seat ring 2. The lower seat ring 1 is made of a hard material, the upper seat ring 2 is made of a soft material, and the upper seat ring 2 is disposed on the lower seat ring 1. The upper seat ring 2 is configured to abut against buttocks of a user. In the embodiment, the soft material is preferably a PU material, and the hard material is preferably a PP material. The upper seat ring 2 and the lower seat ring 1 are matched and connected to form a heating cavity 3. A heating assembly 4 is disposed in the heating cavity 3, and the heating assembly 4 is configured to emit heat to heat the upper seat ring 2, so that the user is more comfortable when sitting on the heating seat ring. Meanwhile, compared with an upper seat ring 2 made of a conventional hard material, the upper seat ring 2 made of the soft material further better transmits the heat emitted through the heating assembly 4, which reduces a loss of heat in a transfer process. Therefore, the heating assembly 4 heats the upper seat ring 2 to a set temperature in a shorter time, thereby achieving the effect of energy saving. At the same time, the heating cavity 3 further plays a role in protecting the heating assembly 4, reducing a possibility that the heating assembly 4 is damaged due to external force.

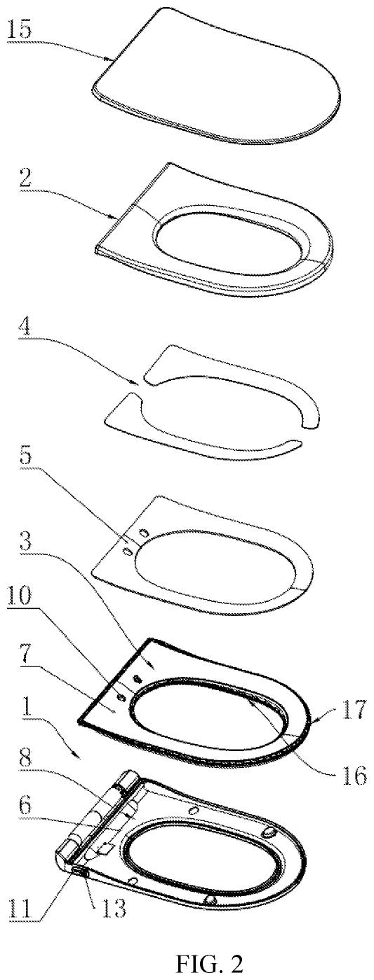

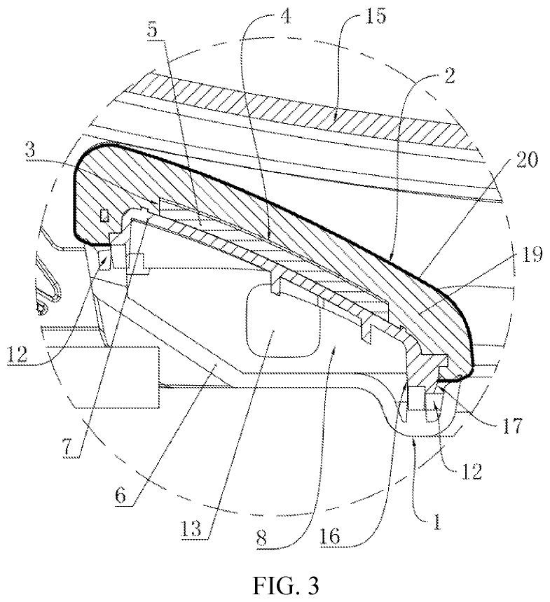

The heating assembly 4 is made of coils or heating wires or heating plates, etc. As shown in FIGS. 2-3, the heating assembly 4 in the present embodiment includes two heating plates, and the heating plates are respectively disposed on a left side of the lower surface of the upper seat ring 2 and a right side of the lower surface of the upper seat ring 2. By adopting a design of the heating plates on the left side and the right side, an installation space of the heating assembly 4 is reduced as much as possible. Meanwhile, the heating assembly 4 accurately heats an area on the upper seat ring 2 where the buttocks of the users abut, and other areas are further naturally influenced by the heat of the area where on the upper seat ring 2 where the buttocks of the users abut, which ensures comfort of use, reduces a volume of the heating assembly 4, and reduces a production cost.

Furthermore, as shown in FIGS. 2-3, a heat insulation plate 5 is further disposed in the heating cavity 3, and the heat insulation plate 5 is disposed on a lower side of the heating assembly 4. The present embodiment reduces downward transfer of the heat of the heating assembly 4 through the heat insulation plate 5, effectively keeps the heat above the heat insulation plate 5, and keeps the temperature of the upper seat ring 2 stable. Then the heating assembly 4 does not need to be repeatedly improved temperature and heated to keep stability of the upper seat ring 2. Finally, the energy-saving effect is further improved while heat preservation is achieved.

As shown in FIG. 3, the heating assembly 4 and the heat insulation plate 5 are attached to each other, and the heating assembly 4 is attached to a lower surface of the upper seat ring 2. The heat insulation plate 5 is attached to an upper surface of the lower seat ring 1, so that the heat of the heating assembly 4 is more effectively transmitted through the fitting design, and the heat insulation plate 5 further effectively isolates a downward transmission of the heat.

Furthermore, as shown in FIG. 3, the heating cavity 3 covers the heating assembly 4 and the heat insulation plate 5, and an inner wall of the heating cavity 3 is attached to a peripheral side of the heating assembly 4 and the heat insulation plate 5. Therefore, the heating assembly 4 and the heat insulation plate 5 are fully coated and tightly attached through the heating cavity 3, the heat is more effectively locked in the heating cavity 3, and the heat is transmitted to the upper seat ring 2.

As shown in FIGS. 2-4, the lower seat ring 1 includes a bottom bracket 6 and a framework plate 7. The framework plate 7 is disposed on the bottom bracket 6. The upper seat ring 2 is coated on the framework plate 7. The upper seat ring 2 and the framework plate 7 are matched and connected to form the heating cavity 3. The framework plate 7 is configured to support the upper seat ring 2, so that the upper seat ring 2 made of the soft material maintains a certain shape. The framework plate 7 and a bottom plate are matched and connected to form a mounting cavity 8. The mounting cavity 8 is configured to mount circuit boards, circuits, components, etc., so that heating of the heating assembly 4 is controlled through the circuits and the components in the mounting cavity 8.

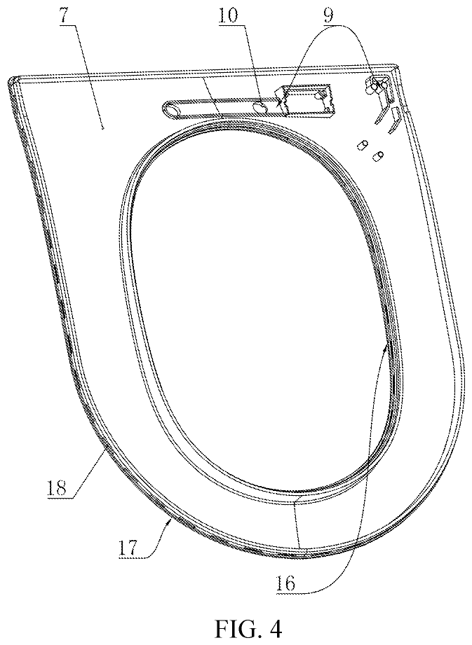

As shown in FIG. 4, a wiring channel 9 is disposed on a lower surface of the framework plate 7, and the wiring channel 9 is configured to guide a layout of the circuits in the mounting cavity 8. Threading holes 10 are defined in the wiring channel 9, and the threading holes 10 are configured to connect and pass between the heating assembly 4 and inner circuits of the mounting cavity 8. A circuit board is disposed on one side of the threading holes 10 in the wiring channel 9, and the circuit board is configured to control the heating assembly 4 and components in the mounting cavity 8.

As shown in FIG. 1 and FIG. 4, a charging interface 11 is disposed on one side of the mounting cavity 8, and the charging interface 11 is connected to the heating assembly 4 through a line. Therefore, a power generation device such as a power bank is connected through the charging interface 11, and the upper seat ring 2 is heated through connecting the power bank to the charging interface 11 during normal power outages, so as to ensure the comfort of use during the power outages. At the same time, an inner end of the charging interface 11 is disposed on one side of an opening of the wiring channel 9, so that the line is directly connected to the charging interface 11 after being disposed and drawn out through the wiring channel 9, thereby making a line connection of the charging interface 11 more direct and convenient.

As shown in FIG. 1, a switch 13 and indicator lights 14 are further disposed on one side of the charging interface 11. The switch 13 is connected to the circuit board in the mounting cavity 8 and the heating assembly 4 through the wires, so as to control the switch 13 of the heating assembly 4. In addition, the indicator lights 14 are disposed on one side of the switch 13, and are further disposed in the switch 13, so as to effectively display whether the heating assembly 4 and the heated upper seat ring 2 are heated to the set temperature through colors of the indicator lights 14.

Furthermore, as shown in FIG. 3, the bottom bracket 6 and the framework plate 7 are connected through thermal welding, so as to improve strength and stability of a connection between the bottom bracket 6 and the frame plate 7. However, due to a fact that the thermal welding connection causes the bottom bracket 6 and the framework plate 7 to melt to generate overflow, an overflow groove 12 is further defined at a joint of the bottom bracket 6 and the framework plate 7. An overflow space of waste generated through melting of the bottom bracket 6 and the framework plate 7 ensures attractiveness and stability of the connection between the bottom bracket 6 and the framework plate 7.

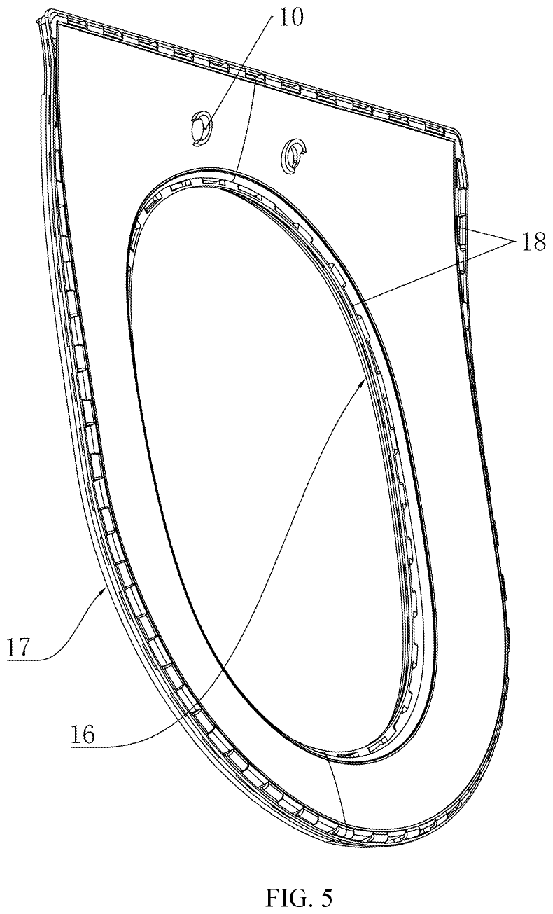

As shown in FIG. 3 and FIG. 5, the framework plate 7 includes an inner ring portion 16 and an outer ring portion 17. A plurality of through holes 18 are respectively defined on the inner ring portion 16 and the outer ring portion 17, and the plurality of the through holes 18 penetrate through an upper surface of the framework plate 7 and the lower surface of the framework plate 7. The upper seat ring 2 includes a foaming layer 19. The foaming layer 19 fills the through holes 18 and covers the inner ring portion 16 of the framework plate 7 and the outer ring portion 17 of the framework plate 7. Therefore, through a filling process, the connection between the framework plate 7 and the upper seat ring 2 is firmer. After the framework plate 7 and the upper seat ring 2 are connected to form a whole, a whole workpiece is welded on the bottom bracket 6 to complete an installation of structure of the heating seat ring where the user sits.

As shown in FIG. 3 and FIG. 5, the upper seat ring 2 further includes a waterproof film 20. The waterproof film 20 is attached to an outer surface of the foaming layer 19. An outer end of the waterproof film 20 and an inner end of the waterproof film 20 are tightly clamped through the bottom bracket 6. Therefore, a water flow is blocked through the waterproof film 20, which protects the foaming layer 19 of the upper seat ring 2 and the components in the heating cavity 3. The waterproof film 20 is preferably a TPU waterproof film.

Furthermore, as shown in FIGS. 1-2, one side of the bottom bracket 6 is bent upwards, and a flip cover 15 is hinged on the one side of the bottom bracket 6. The flip cover 15 is rotatably disposed on the upper seat ring 2, which protects the upper seat ring 2.

Basic principles and main features of the present disclosure and advantages of the present disclosure are shown and described above. It should be understood by a person skilled in art that the present disclosure is not limited by the above mentioned embodiments. The above mentioned embodiments and descriptions are merely to illustrate the principles of the present disclosure, and various changes and improvements are made in the present disclosure without departing from spirit and scope of the present disclosure, and the changes and the improvements all fall within the scope of the present disclosure as claimed. The scope of the present disclosure is defined by the appended claims and equivalents.

What is claimed is:

1. A heating seat ring, comprising:
a lower seat ring; and
an upper seat ring;
wherein the lower seat ring is made of a hard material, the upper seat ring is made of a soft material, and the upper seat ring is disposed on the lower seat ring; the upper seat ring and the lower seat ring are matched and connected to form a heating cavity, a heating assembly is disposed in the heating cavity, and the heating assembly is configured to emit heat to heat the upper seat ring.

2. The heating seat ring according to claim 1, wherein the lower seat ring comprises a framework plate, the upper seat ring is coated on the framework plate, and the upper seat ring and the framework plate are matched and connected to form the heating cavity.

3. The heating seat ring according to claim 2, wherein a heat insulation plate is disposed in the heating cavity, and the heat insulation plate is disposed on a lower side of the heating assembly.

4. The heating seat ring according to claim 3, wherein the heating assembly and the heat insulation plate are attached to each other, and the heating assembly is attached to a lower surface of the upper seat ring.

5. The heating seat ring according to claim 1, wherein the heating assembly comprises two heating plates, and the heating plates are respectively disposed on a left side of the lower surface of the upper seat ring and a right side of the lower surface of the upper seat ring.

6. The heating seat ring according to claim 2, wherein the lower seat ring further comprises a bottom bracket, the framework plate is disposed on the bottom bracket, the framework plate and the bottom bracket are matched and connected to form a mounting cavity, the mounting cavity is configured to mount a circuit and components.

7. The heating seat ring according to claim 6, wherein a wiring channel is disposed on a lower surface of the framework plate, a charging interface is disposed on one side of the mounting cavity, the charging interface is connected to the heating assembly through a line, an inner end of the charging interface is disposed on one side of an opening of the wiring channel.

8. The heating seat ring according to claim 1, wherein the framework plate comprises an inner ring portion and an outer ring portion, a plurality of through holes are respectively defined on the inner ring portion and the outer ring portion, the plurality of the through holes penetrate through an upper surface of the framework plate and the lower surface of the framework plate;
the upper seat ring comprises a foaming layer, and the foaming layer fills the through holes and covers the inner ring portion of the framework plate and the outer ring portion of the framework plate.

9. The heating seat ring according to claim 8, wherein the upper seat ring further comprises a waterproof film, the waterproof film is attached to an outer surface of the foaming layer, and an outer end of the waterproof film and an inner end of the waterproof film are tightly clamped through the bottom bracket.

10. The heating seat ring according to claim 6, wherein the bottom bracket and the framework plate are connected through thermal welding, and an overflow groove is defined at a joint of the bottom bracket and the framework plate.
